(19) United States
(12) Patent Application Publication
(10) Pub. No.: US 2025/0330334 A1
(43) Pub. Date: Oct. 23, 2025

(54) KEY EXCHANGE SYSTEM, EQUIPMENT, METHOD, AND PROGRAM

(71) Applicant: NIPPON TELEGRAPH AND TELEPHONE CORPORATION, Tokyo (JP)

(72) Inventors: Yusuke IIJIMA, Tokyo (JP); Fumiaki KUDO, Tokyo (JP)

(21) Appl. No.: 18/868,984

(22) PCT Filed: Jun. 14, 2022
(86) PCT No.: PCT/JP2022/023866

§ 371 Date: Nov. 25, 2024

(51) Int. Cl. H04L 9/32; H04L 9/08

(52) U.S. Cl. CPC H04L 9/3263; H04L 9/0861; H04L 9/3247

(57) ABSTRACT

A key exchange system according to one aspect of the present disclosure is a key exchange system that realizes a key exchange with authentication between a first instrument that performs authentication based on an ID-based encryption and a second instrument that performs authentication based on an electronic certificate, wherein the first instrument includes a first verification unit configured to verify the electronic certificate, a second verification unit configured to verify a signature generated by the second instrument by using a verification key associated with the electronic certificate when the verification of the electronic certificate is successful, and a first session key generation unit configured to generate a session key to be used for encrypted communication with the second instrument by using the electronic certificate and shared information generated by a pairing operation when the verification of the signature is successful, and the second instrument includes a signature generation unit configured to generate the signature by using a signature key corresponding to the verification key, and a second session key generation unit configured to generate a session key to be used for the encrypted communication with the first instrument by using the electronic certificate and the shared information generated by the pairing operation.

### TECHNICAL FIELD

The present disclosure relates to a key exchange system, an instrument, a method, and a program.

### BACKGROUND ART

Performing an authentication for confirming whether or not correct instruments are mutually connected with each other is more important in cases where IoT (Internet of Things) instruments communicate with each other or IoT instrument communicates with gateway server, cloud server, or the like. For this reason, it is required for the IoT instrument to use a key exchange with authentication technique.

As one of the key exchange with authentication techniques, a key exchange with authentication protocol using an ID-based encryption is known. The key exchange with authentication protocol using the ID-based encryption is generally realized by using a bilinear group in an elliptic curve on a finite field. Such a bilinear group is also called a pairing group, and can be classified into a symmetric pairing group and an asymmetric pairing group. At present, when the pairing group is used for the encryption, the asymmetric pairing group is often used from the viewpoint of efficiency and safety.

On the other hand, since, in the ID-based encryption, a server called KGC (Key Generation Center) generates a secret key of a terminal, the administrator of the IoT instrument has a high possibility of operating KGC by himself or herself instead of using an external KGC service. Therefore, for example, when the IoT instrument and the cloud server or the like communicate with each other, the IoT instrument side sometimes performs the authentication (hereinafter, also referred to as ID-based authentication) based on the ID-based encryption, and the cloud server side performs the authentication based on an electronic certificate (hereinafter referred to as PKI (Public Key Infrastructure, public key encryption basis)-based authentication). In Non Patent Literatures 1 to 3, an authentication system in which one instrument adopts the ID-based authentication and the other instrument adopts the PKI-based authentication (such authentication system is also called a mixed authentication system or simply mixed authentication) is described.

### Citation List

### Non Patent Literature

Non Patent Literature 1: Ustaoglu, B. Integrating identity-based and certificate-based authenticated key exchange protocols. Int. J. Inf. Secur. 10, 201-212 (2011).
Non Patent Literature 2: Guo Y., Zhang Z. Authenticated Key Exchange with Entities from Different Settings and Varied Groups. In: Takagi T., Wang G., Qin Z., Jiang S., Yu Y. (eds) Provable Security. ProvSec 2012.
Non Patent Literature 3: Koutarou Aoyagi, Hiroki Okano, Akira Nagai, Koutarou Suzuki. PKI-ID mixed authentication key exchange with safety and efficient calculation for the maximum key leakage attack, SCIS 2022.

### SUMMARY OF INVENTION

### Technical Problem

However, in the conventional mixed authentication system, the electronic certificate used in the PKI-based authentication depends on the ID-based authentication of a communication partner. Specifically, an instrument adopting the PKI-based authentication needs to generate a public key associated with its own electronic certificate by using the elliptic curve used for the ID-based authentication adopted by the communication partner.

Therefore, the instrument adopting the PKI-based authentication cannot use any public key, and needs to issue the electronic certificate for the communication partner adopting the ID-based authentication.

The present disclosure has been made in view of the above-mentioned point, and provides a technique capable of realizing the key exchange with authentication by mixed authentication of the ID-based authentication and the PKI-based authentication independent of the ID-based authentication.

### Solution to Problem

A key exchange system according to one aspect of the present disclosure is a key exchange system that realizes a key exchange with authentication between a first instrument that performs authentication based on an ID-based encryption and a second instrument that performs authentication based on an electronic certificate, wherein the first instrument includes a first verification unit configured to verify the electronic certificate, a second verification unit configured to verify a signature generated by the second instrument by using a verification key associated with the electronic certificate when the verification of the electronic certificate is successful, and a first session key generation unit configured to generate a session key to be used for encrypted communication with the second instrument by using the electronic certificate and shared information generated by a pairing operation when the verification of the signature is successful, and the second instrument includes a signature generation unit configured to generate the signature by using a signature key corresponding to the verification key, and a second session key generation unit configured to generate a session key to be used for the encrypted communication with the first instrument by using the electronic certificate and the shared information generated by the pairing operation.

### Advantageous Effects of Invention

A technique capable of realizing the key exchange with authentication by the mixed authentication of the ID-based authentication and the PKI-based authentication independent of the ID-based authentication is provided.

### BRIEF DESCRIPTION OF DRAWINGS

FIG. 1 is a diagram showing an overall configuration example of a key exchange with authentication system according to a present embodiment.

FIG. 2 is a diagram showing a functional configuration example of the key generation device according to the present embodiment.

FIG. 3 is a diagram showing a functional configuration example of a certificate authority according to the present embodiment.

FIG. 4 is a diagram showing a functional configuration example of a first communication instrument according to the present embodiment.

FIG. 5 is a diagram showing a functional configuration example of a second communication instrument according to the present embodiment.

FIG. 6 is a flowchart showing an example of setup processing.

FIG. 7 is a sequence diagram showing an example of long-term secret key generation processing.

FIG. 8 is a sequence diagram showing an example of signature key generation and certification issue processing.

FIG. 9 is a sequence diagram showing an example of key exchange with authentication processing.

FIG. 10 is a diagram showing a hardware configuration example of a computer.

### DESCRIPTION OF EMBODIMENTS

Hereinafter, one embodiment of the present invention will be described. In the following embodiment, a key exchange with authentication system 1 which realizes a key exchange with authentication by a mixed authentication of an ID-based authentication and a PKI-based authentication independent of the ID-based authentication will be described.

### Overall Configuration Example

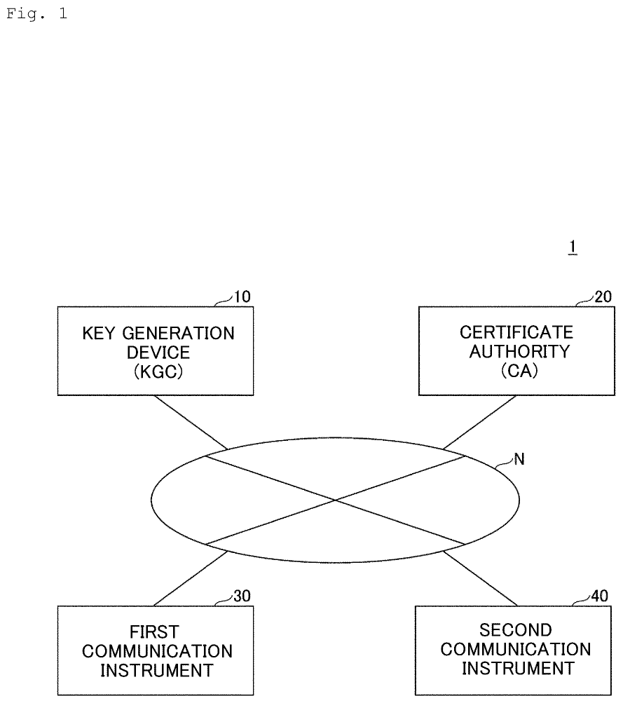

FIG. 1 shows an overall configuration example of the key exchange with authentication system 1 according to a present embodiment. As shown in FIG. 1, the key exchange with authentication system 1 according to the present embodiment includes a key generation device 10, a certificate authority 20, a first communication instrument 30, and a second communication instrument 40. These are connected with each other in a communicable manner via a communication network N including the Internet or the like.

The key generation device 10 is a server or a server group functioning as a KGC of an ID-based encryption. The key generation device 10 executes setup processing of the ID-based encryption, and generates a long-term secret key of the first communication instrument 30 adopting the ID-based authentication.

The certificate authority 20 is a server or a server group functioning as a CA (Certification Authority) of PKI. The certificate authority 20 generates an electronic certificate (hereinafter referred to simply as a certificate) for a public key of the second communication instrument 40 adopting a PKI-based authentication.

The first communication instrument 30 is an instrument that adopts the ID-based authentication (that is, an instrument that performs authentication using the ID-based encryption). Hereinafter, an identifier for uniquely identifying the first communication instrument 30 is referred to as ID_{c}. Note that, as the identifier ID_{c}, for example, a manufacturing unique number, a user ID, a mail address, a telephone number, an IP (Internet Protocol) address, a MAC (Media Access Control) address, or the like can be used.

In addition, hereinafter, the first communication instrument 30 is assumed to be an IoT instrument. However, the first communication instrument 30 is not limited to this and includes, for example, a smart phone, a tablet terminal, a PC (personal computer), a general-purpose server, or the like.

The second communication instrument 40 is an instrument adopting the PKI-based authentication (that is, an instrument performing authentication using the electronic certificate). Hereinafter, an identifier for uniquely identifying the second communication instrument 40 is referred to as IDₛ. Note that, as the identifier IDₛ, for example, a manufacturing unique number, a user ID, a mail address, a telephone number, an IP address, a MAC address, or the like can be used.

In addition, hereinafter, the second communication instrument 40 is assumed to be a general-purpose server (for example, an edge server, a gateway server, a cloud server, or the like). However, the second communication instrument 40 is not limited to this, and includes, for example, an IoT instrument, a smart phone, a tablet terminal, a PC or the like.

Note that the overall configuration of the key exchange with authentication system 1 shown in FIG. 1 is an example, and is not limited thereto. For example, although only one first communication instrument 30 and one second communication instrument 40 are shown in the example shown in FIG. 1, a plurality of first communication instruments 30 may be present or a plurality of second communication instruments 40 may be present in the same manner.

### Functional Configuration Example

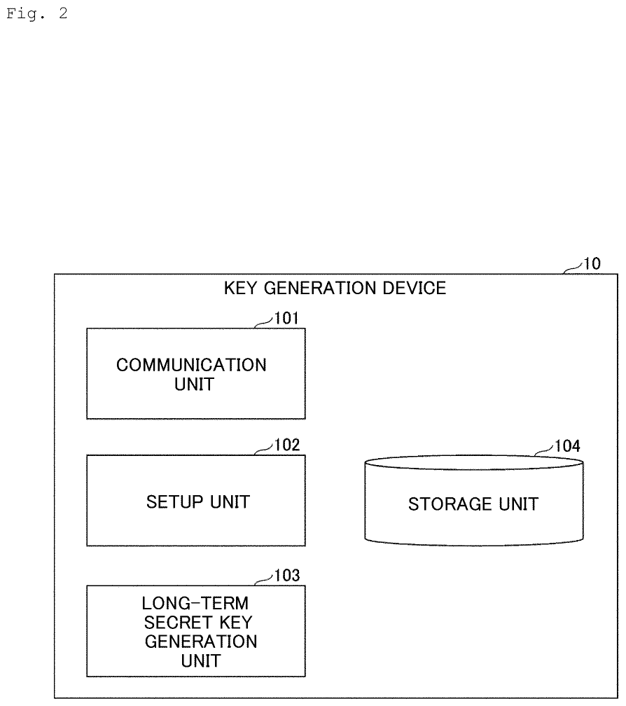

FIG. 2 to FIG. 5 show functional configuration examples of the key generation device 10, the certificate authority 20, the first communication instrument 30, and the second communication instrument 40 included in the key exchange with authentication system 1 according to the present embodiment.

### Key Generation Device 10

As shown in FIG. 2, the key generation device 10 according to the present embodiment has a communication unit 101, a setup unit 102, and a long-term secret key generation unit 103. These units are realized by processing in which one or more programs installed in the key generation device 10 cause a processor such as a CPU (Central Processing Unit) to execute them. In addition, the key generation device 10 according to the present embodiment has a storage unit 104. The storage unit 104 is, for example, realized by a storage device such as an HDD (Hard Disk Drive) or an SSD (Solid State Drive).

The communication unit 101 performs various types of communication with other instruments and between other devices. The setup unit 102 executes setup processing of the ID-based encryption. The long-term secret key generation unit 103 generates a long-term secret key of the first communication instrument 30. The storage unit 104 stores various types of information (for example, a master secret key, a master public key, a public parameter, and the like of the ID-based encryption).

### Certificate Authority 20

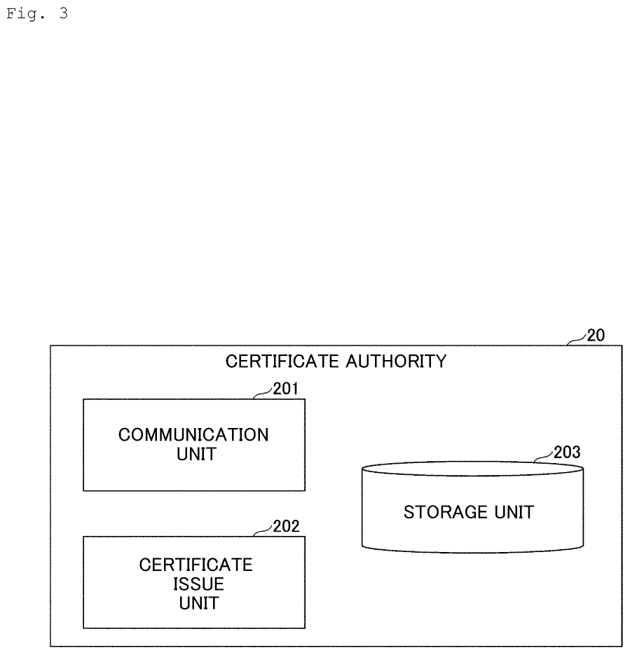

As shown in FIG. 3, the certificate authority 20 according to the present embodiment has a communication unit 201 and a certificate issue unit 202. These units are realized by, for example, processing in which one or more programs installed in the certificate authority 20 cause the processor such as the CPU to execute them. In addition, the certificate authority 20 according to the present embodiment has a storage unit 203. The storage unit 203 is realized by a storage device such as an HDD or an SSD, for example.

The communication unit 201 performs various types of communication with other devices and between other devices. The certificate issue unit 202 issues a certificate to a public key of the second communication instrument 40. The storage unit 203 stores various types of information (for example, a secret key of a certificate authority or the like necessary for issuing a certificate).

### First Communication Instrument 30

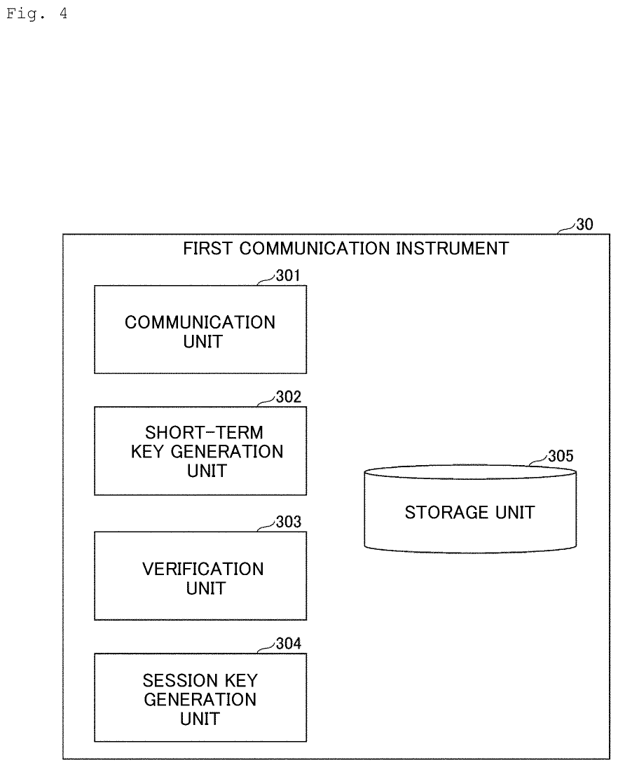

As shown in FIG. 4, the first communication instrument 30 according to the present embodiment has a communication unit 301, a short-term key generation unit 302, a verification unit 303, and a session key generation unit 304. These units are realized by, for example, processing in which one or more programs installed in the first communication instrument 30 cause the processor such as an MPU (Micro Processor Unit) to execute them. In addition, the first communication instrument 30 according to the present embodiment has a storage unit 305. The storage unit 305 is realized by a storage device such as a flash memory, for example.

The communication unit 301 performs various types of communication with other devices and between other devices. The short-term key generation unit 302 generates its own short-term secret key and short-term public key in key exchange with authentication with the second communication instrument 40. The verification unit 303 verifies a certificate for the public key (verification key) of the second communication instrument 40 and a signature generated by the second communication instrument 40 in the key exchange with authentication with the second communication instrument 40. The session key generation unit 304 generates a session key shared with the second communication instrument 40 in the key exchange with authentication with the second communication instrument 40. The storage unit 305 stores various types of information (for example, an identifier ID_{c}, its own long-term secret key, a short-term secret key, a short-term public key, a public parameter, or the like).

### Second Communication Instrument 40

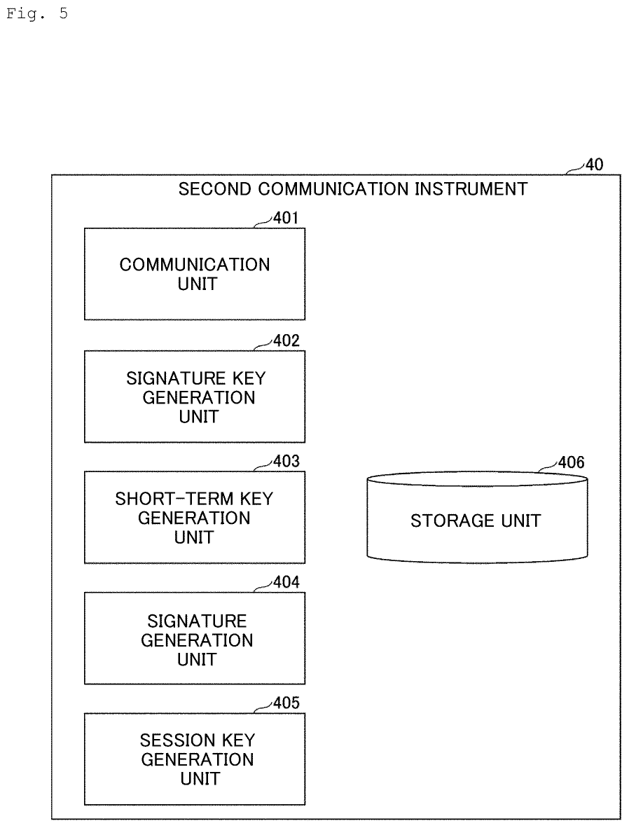

As shown in FIG. 5, the second communication instrument 40 according to the present embodiment has a communication unit 401, a signature key generation unit 402, a short-term key generation unit 403, a signature generation unit 404, and a session key generation unit 405. These units are realized by, for example, processing in which one or more programs installed in the second communication instrument 40 cause the processor such as the CPU to execute them. In addition, the second communication instrument 40 according to the present embodiment has a storage unit 406. The storage unit 406 is realized by a storage device such as the HDD or the SSD, for example.

The communication unit 401 communicates with other devices and between other devices. The signature key generation unit 402 generates a signature key and a verification key as a secret key and a public key. The short-term key generation unit 403 generates its own short-term secret key and short-term public key in the key exchange with authentication with the first communication instrument 30. The signature generation unit 404 generates its own signature in the key exchange with authentication with the first communication instrument 30. The session key generation unit 405 generates a session key shared with the first communication instrument 30. The storage unit 406 stores various types of information (for example, an identifier IDₛ, its own signature key and verification key, a certificate for the verification key (public key), a short-term secret key, a short-term public key, a public parameter (at least a part of them), or the like).

### Details of Processing

Next, various types of processing executed by the key exchange with authentication system 1 according to the present embodiment will be described.

### Preparation

First, some symbols, concepts, and the like are prepared.

p is defined as a prime number, and an additive group formed by residue classes modulo p in the additive group of an integer is defined as Zₚ.

A bilinear group G=(p, G₁, G₂, G_{T}, g₁, g₂, e) is constituted by the prime number p, a cyclic group G₁, G₂, G_{T} of an order p, a generator g₁ of G₁, a generator g₂ of G₂, and a bilinear map e: G₁×G₂→G_{T} satisfying the following bilinearity and non-degenerate.

Bilinearity: e(h₁^{a}, h₂^{b})=e(h₁, h₂)^{ab} is satisfied for arbitrary h₁∈G₁, h₂∈G₂, and a, b∈Zₚ.

Non-degenerate: e(g₁, g₂) is a generator of G_{T}.

As an example of such a bilinear group, Optimal-ate paring and the like described in Reference Document 1 is cited.

In addition, H₁, H₂, and H₃ are defined as a hash function generating an element on Zₚ from a character string (for example, bit string) and H is defined as a key derivation function. These hash functions H₁, H₂, H₃ and the key derivation function H are assumed to be held by a device or an instrument requiring the parameters as common parameters of the whole system.

### Setup Processing

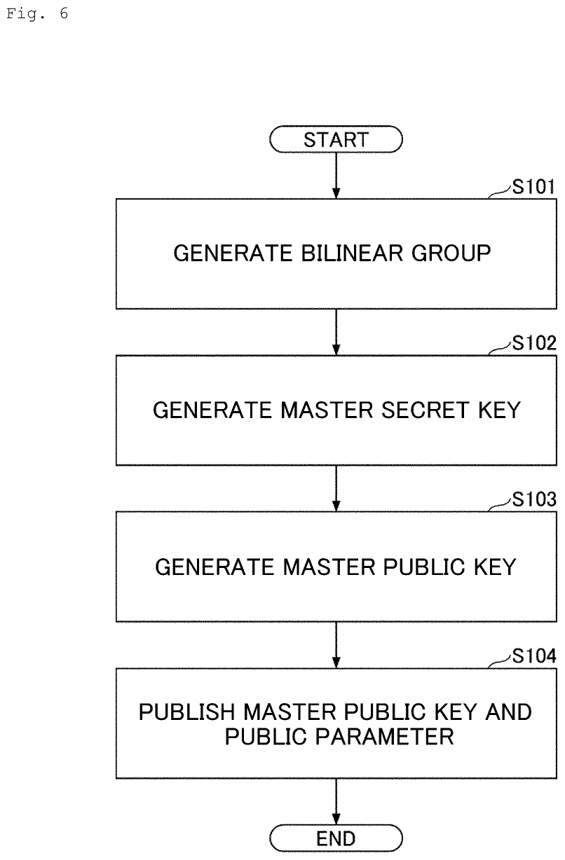

Hereinafter, setup processing will be described with reference to FIG. 6.

The setup unit 102 of the key generation device 10 generates a bilinear group G=(p, G₁, G₂, G_{T}, g₁, g₂, e) (step S101). Note that the bilinear group G is stored in the storage unit 104.

Next, the setup unit 102 of the key generation device 10 generates a master secret key w∈Zₚ uniformly at random (step S102). Note that the master secret key w is stored in the storage unit 104.

Next, the setup unit 102 of the key generation device 10 generates a master public key W=g₁^{w} (step S103). Note that the master public key W is stored in the storage unit 104.

Then, the setup unit 102 of the key generation device 10 publishes the master public key W and the public parameter pp (step S104). Here, although the public parameter satisfies pp=G, the public parameter may include the master public key and may be defined as pp=(G, W). In addition, the hash functions H₁, H₂, H₃ and the key derivation function H are defined as common parameters of the whole system, but it is not limited to this, it may be included in the public parameter pp. In the following description, it is assumed that the first communication instrument 30 and the second communication instrument 40 hold the master public key W and the public parameter pp.

### Long-Term Secret Key Generation Processing

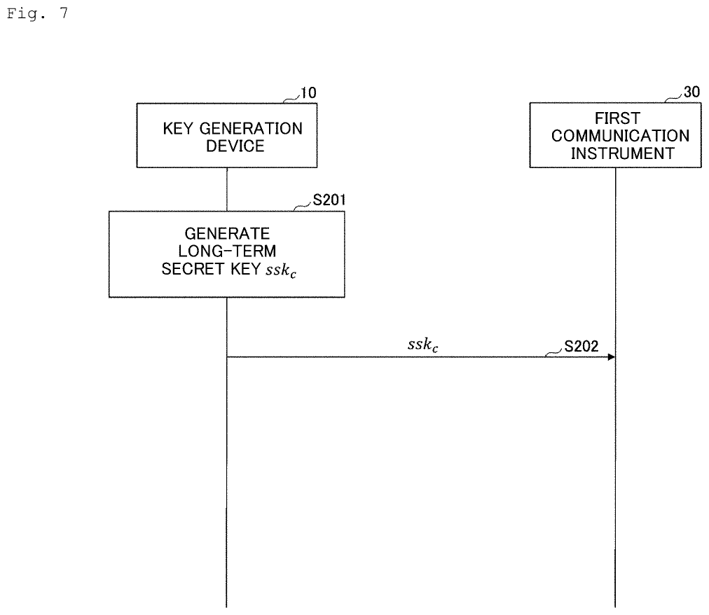

Hereinafter, long-term secret key generation processing will be described with reference to FIG. 7.

The long-term secret key generation unit 103 of the key generation device 10 uses the master secret key w and the identifier ID_{c} of the first communication instrument 30 to generate a long-term secret key ssk_{c} corresponding to the ID_{c} as follows (step S201).

$${ssk}_{c} = {g}_{2}^{1 / ( w + {H}_{3} ( {ID}_{C} ) )} \qquad [ Math . 1 ]$$

Note that, although the identifier ID_{c} is published to the key generation device 10, it may be transmitted from the first communication instrument 30 to the key generation device 10, for example, before the present step.

Then, the communication unit 101 of the key generation device 10 transmits the long-term secret key ssk_{c} to the first communication instrument 30 (step S202). At this time, the communication unit 101 transmits the long-term secret key ssk, to the first communication instrument 30 through an arbitrary safe communication path. Note that this long-term secret key ssk_{c} is stored in the storage unit 305 of the first communication instrument 30.

### Signature Key Generation and Certificate Issue Processing

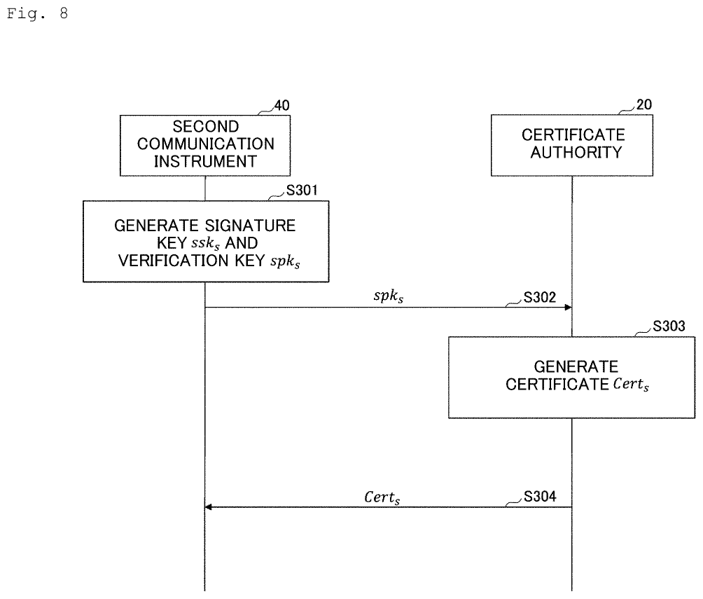

Hereinafter, signature key generation and certificate issue processing will be described with reference to FIG. 8.

The signature key generation unit 402 of the second communication instrument 40 generates a signature key sskₛ and a verification key spkₛ by an arbitrary signature system (step S301). The signature key generation unit 402 generates the signature key sskₛ and the verification key spkₛ by the arbitrary signature system, however, as an example of such a signature system, for example, an RSA encryption signature, a DSA signature, an ECDAS signature, a lattice-based encryption signature, and the like are cited. Note that the signature key sskₛ and the verification key spkₛ are stored in the storage unit 406.

Thus, the second communication instrument 40 can generate the signature key and the verification key (secret key and public key) by the arbitrary signature system without depending on the ID-based authentication used by the communication partner.

The communication unit 401 of the second communication instrument 40 transmits the verification key spkₛ to the certificate authority 20 (step S302).

The certificate issue unit 202 of the certificate authority 20 generates a certificate Certₛ for the verification key spkₛ (step S303).

Then, the communication unit 201 of the certificate authority 20 transmits the certificate Certₛ to the second communication instrument 40 (step S304). Note that the certificate Certₛ is stored in the storage unit 406 of the second communication instrument 40.

Key Exchange with Authentication Processing

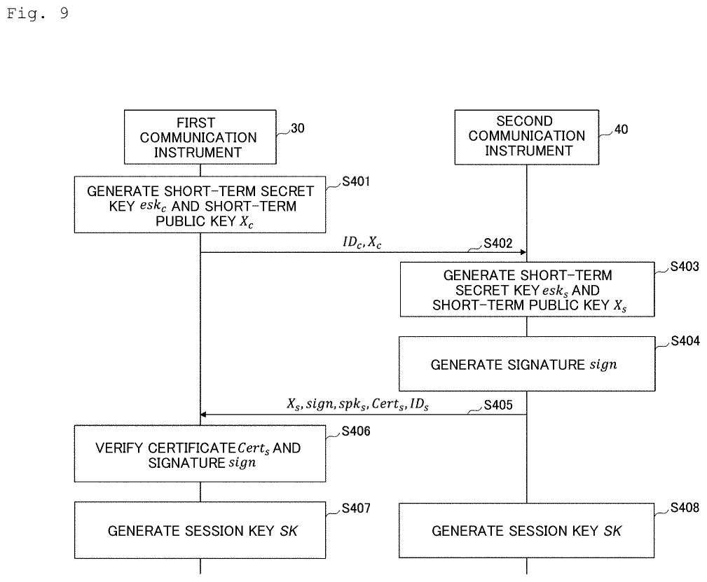

Next, key exchange with authentication processing for sharing a session key SK between the first communication instrument 30 and the second communication instrument 40 will be described with reference to FIG. 9.

The short-term key generation unit 302 of the first communication instrument 30 generates a short-term secret key esk_{c}∈Zₚ uniformly at random, and generates a short-term public key X, as follows (step S401).

$${x}_{c} = {H}_{1} ( {ssk}_{c} , {esk}_{c} ) \qquad [ Math . 2 ]$$

$${X}_{c} = {g}_{1}^{{x}_{c}}$$

The communication unit 301 of the first communication instrument 30 transmits its own identifier ID_{c} and the short-term public key X_{c} to the second communication instrument 40 (step S402).

The short-term key generation unit 403 of the second communication instrument 40 generates a short-term secret key eskₛ∈Zₚ uniformly at random, and generates a short-term public key Xₛ as follows (step S403).

$${x}_{s} = {H}_{1} ( {ssk}_{s} , {esk}_{s} ) \qquad [ Math . 3 ]$$

$${X}_{s} = {( W {g}_{1}^{{H}_{1} ( {ID}_{c} )} )}^{{x}_{s}}$$

Next, a signature generation unit 404 of the second communication instrument 40 generates a signature sign as follows (step S404).

$$sign = {Sign}_{{ssk}_{s}} ( {X}_{s} , {ID}_{c} , {ID}_{s} ) \qquad [ Math . 4 ]$$

Here, Signₛₛₖ(m) is a signature generation algorithm for generating a signature sign for a message m by using the signature key ssk. Note that, in the above-mentioned Math. 4, for example, a combination of bit strings representing Xₛ, ID_{c}, and IDₛ may be used as the message m.

The communication unit 401 of the second communication instrument 40 transmits the short-term public key Xₛ, the signature sign, the verification key spkₛ, the certificate Certₛ, and the identifier IDₛ to the first communication instrument 30 (step S405).

The verification unit 303 of the first communication instrument 30 verifies the certificate Certₛ, and further verifies the signature sign when the verification is successful (step S406). Hereinafter, it is assumed that the verification of the signature sign has also succeeded. In this way, the first communication instrument 30 can authenticate the second communication instrument 40 by further verifying the signature sign when the verification of the certificate Certₛ is successful.

The session key generation unit 304 of the first communication instrument 30 generates the session key SK as follows (step S407).

$${d}_{c} = {H}_{2} ( {X}_{c} , {ID}_{c} , {ID}_{s} ) \qquad [ Math . 5 ]$$

$${d}_{s} = {H}_{2} ( {X}_{s} , sign , {spk}_{s} , {Cert}_{s} , {ID}_{c} , {ID}_{s} )$$

$${D}_{c} = {( {{X}_{s} ( W {g}_{1}^{{H}_{1} ( {ID}_{c} )} )}^{{d}_{s}} )}^{{x}_{c} + {d}_{c}}$$

$$\begin{matrix}{σ}_{1} & = e ( {D}_{c} , {ssk}_{c} ) \\ & = {g}_{T}^{( {x}_{c} + {d}_{c} ) ( {x}_{s} + {d}_{s} )}\end{matrix}$$

$$SK = H ( {σ}_{1} , {ID}_{c} , {ID}_{s} , {X}_{c} , {X}_{s} , sign , {spk}_{s} , {Cert}_{s} )$$

In addition, the session key generation unit 405 of the second communication instrument 40 generates the session key SK as follows (step S408).

$${d}_{c} = {H}_{2} ( {X}_{c} , {ID}_{c} , {ID}_{s} ) \qquad [ Math . 6 ]$$

$${d}_{s} = {H}_{2} ( {X}_{s} , sign , {spk}_{s} , {Cert}_{s} , {ID}_{c} , {ID}_{s} )$$

$${D}_{s} = {( {X}_{c} {g}_{1}^{{d}_{c}} )}^{{x}_{c} + {d}_{c}}$$

$$\begin{matrix}{σ}_{1} & = e ( {D}_{s} , {g}_{2} ) \\ & = {g}_{T}^{( {x}_{c} + {d}_{c} ) ( {x}_{s} + {d}_{s} )}\end{matrix}$$

$$SK = H ( {σ}_{1} , {ID}_{c} , {ID}_{s} , {X}_{c} , {X}_{s} , sign , {spk}_{s} , {Cert}_{s} )$$

Thus, the second communication instrument 40 can authenticate the first communication instrument 30, and the session key SK is shared between the first communication instrument 30 and the second communication instrument 40. In addition, when the session key SK is generated by the above-mentioned Math. 5 and Math. 6, the signature sign and the verification key (public key) spkₛ are also set to the input of the key derivation function H, so that the security of key exchange can be secured. However, either or both of the signature sign and the verification key spkₛ may not be the input of the key derivation function H.

Note that the first communication instrument 30 and the second communication instrument 40 can perform encrypted communication using the session key SK thereafter.

### Hardware Configuration Example

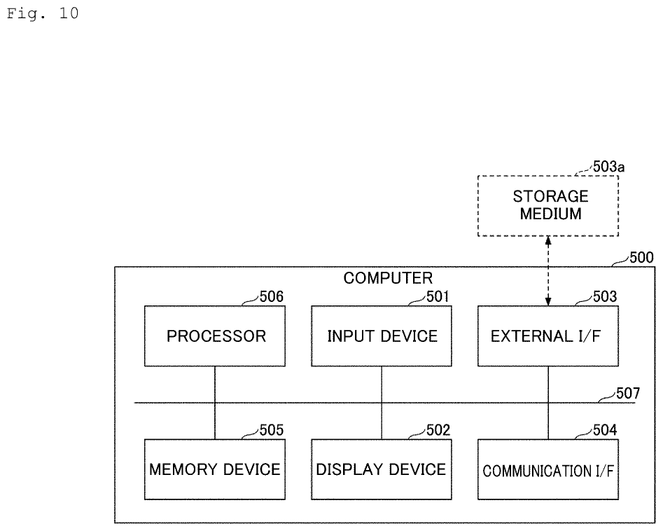

The key generation device 10, the certificate authority 20, the first communication instrument 30, and the second communication instrument 40 included in the key exchange with authentication system 1 according to the present embodiment are realized by, for example, a hardware configuration of a computer 500 shown in FIG. 10. The computer 500 shown in FIG. 10 has an input device 501, a display device 502, an external I/F 503, a communication I/F 504, a memory device 505, and a processor 506. Each piece of this hardware is communicably connected with each other via a bus 507.

The input device 501 is, for example, a keyboard, a mouse, a touch panel, a physical button, or the like. The display device 502 is, for example, a display, a display panel, or the like. Note that the computer 500 may not include, for example, at least one of the input device 501 and the display device 502.

The external I/F 503 is an interface with an external device such as a recording medium 503a. The computer 500 can read from and write to the recording medium 503a via the external I/F 503. As the recording medium 503a, for example, a flexible disk, a CD (Compact Disc), a DVD (Digital Versatile Disk), an SD memory card (Secure Digital memory card), a USB (Universal Serial Bus) memory card, and the like are cited.

The communication I/F 504 is an interface for connecting the computer 500 to various networks. The memory device 505 is, for example, one of various storage devices such as a RAM (Random Access Memory), a ROM (Read Only Memory), an HDD (Hard Disk Drive), an SSD (Solid State Drive), and a flash memory. The processor 506 is, for example, various arithmetic units such as a CPU, an MPU, and a GPU (Graphics Processing Unit).

The key generation device 10, the certificate authority 20, the first communication instrument 30, and the second communication instrument 40 included in the key exchange with authentication system 1 according to the present embodiment can realize the various types of above-described processing by having the hardware configuration of the computer 500 shown in FIG. 10. Note that the hardware configuration of the computer 500 shown in FIG. 10 is an example and is not limited to this. For example, the computer 500 may include a plurality of memory devices 505 and a plurality of processors 506, may not include a part of pieces of illustrated hardware, or may include various pieces of hardware other than the illustrated hardware. Further, the key generation device 10, the certificate authority 20, and the second communication instrument 40 may be realized by a system having a device or an instrument realized by a hardware configuration of the computer 500 shown in FIG. 10 as constituent components.

### Summary

As described above, the key exchange with authentication system 1 according to the present embodiment can perform the key exchange with authentication between the first communication instrument 30 adopting the ID-based authentication and the second communication instrument 40 adopting the PKI-based authentication. In addition, at this time, in the key exchange with authentication system 1 according to the present embodiment, the public key (verification key) associated with the certificate used by the second communication instrument 40 does not depend on the ID-based authentication adopted by the first communication instrument 30. Therefore, in the key exchange with authentication system 1 according to the present embodiment, it is not necessary to issue the certificate for the first communication instrument 30, and it is possible to suppress the time and cost required for issuing the certificate.

The present invention is not limited to the specifically disclosed embodiments, and various modifications, changes, combinations with known techniques, and the like can be made without departing from the scope of the claims.

### Reference Document

Reference Document 1: K. Kasamatsu, S. Kanno, T. Kobayashi and Y. Kawahara: Optimal Ate Pairing draftkasamatsu-optimal-ate-pairings-00. Network Working Group Internet-Draft: to apper. Vercauteren, F.: Optimal pairings. IEEE Trans. Inf. Theory 56, 455-461 (2010)

### Reference Signs List

1 Key exchange with authentication system
10 Key generation device
20 Certificate authority
30 First communication instrument
40 Second communication instrument
101 Communication unit
102 Setup unit
103 Long-term secret key generation unit
104 Storage unit
201 Communication unit
202 Certificate issue unit
203 Storage unit
301 Communication unit
302 Short-term key generation unit
303 Verification unit
304 Session key generation unit
305 Storage unit
401 Communication unit
402 Signature key generation unit
403 Short-term key generation unit
404 Signature generation unit
405 Session key generation unit
406 Storage unit
500 Computer
501 Input device
502 Display device
503 External I/F
503a Recording medium
504 Communication I/F
505 Memory device
506 Processor
507 Bus
N Communication network

1. A key exchange system that realizes a key exchange with authentication between a first instrument that performs authentication based on an ID-based encryption and a second instrument that performs authentication based on an electronic certificate, wherein
the first instrument comprises
a first processor; and
a first memory storing first program instructions that cause the first processor to:
verify the electronic certificate,
verify a signature generated by the second instrument by using a verification key associated with the electronic certificate when the verification of the electronic certificate is successful, and
generate a session key to be used for encrypted communication with the second instrument by using the electronic certificate and shared information generated by a pairing operation when the verification of the signature is successful, and
the second instrument comprises
a second processor; and
a second memory storing second program instructions that cause the second processor to:
generate the signature by using a signature key corresponding to the verification key, and
generate a session key to be used for the encrypted communication with the first instrument by using the electronic certificate and the shared information generated by the pairing operation.

2. The key exchange system according to claim 1, wherein
the first program instructions cause the first processor to generate the session key by further using at least one of the signature and the verification key, and
the second program instructions cause the second processor to generate the session key by further using at least one of the signature and the verification key.

3. The key exchange system according to claim 1, wherein
the second program instructions cause the second processor to generate the verification key and the signature key by a predetermined signature system independent of the ID-based encryption.

4. An instrument configured to perform authentication based on an ID-based encryption and perform a key exchange with authentication with another instrument for performing authentication based on an electronic certificate, the instrument comprising:
a processor; and
a memory storing program instructions that cause the processor to:
verify the electronic certificate;
verify a signature generated by the other instrument by using the verification key associated with the electronic certificate when the verification of the electronic certificate is successful; and
generate the session key to be used for encrypted communication with the other instrument by using the electronic certificate and shared information generated by a pairing operation when the verification of the signature is successful.

5. (canceled)

6. A method that realizes a key exchange with authentication between a first instrument that performs authentication based on an ID-based encryption and a second instrument that performs authentication based on an electronic certificate, the method comprising:
verifying, by the first instrument, the electronic certificate,
verifying, by the first instrument, a signature generated by the second instrument by using a verification key associated with the electronic certificate when the verification of the electronic certificate is successful, and
generating, by the first instrument, a session key used for encrypted communication with the second instrument by using the electronic certificate and shared information generated by a pairing operation when the verification of the signature is successful,
generating, by the second instrument, the signature by using a signature key corresponding to the verification key, and
generating, by the second instrument, a session key to be used for encrypted communication with the first instrument by using the electronic certificate and the shared information generated by the pairing operation.

7. A non-transitory computer-readable recording medium having stored therein a program causing a computer to perform the method according to claim 6.
